(19) United States
(12) Patent Application Publication
(10) Pub. No.: US 2011/0220385 A1
(43) Pub. Date: Sep. 15, 2011

(54) Connection of Electrical Cables by Ultrasonic Welding

(75) Inventors: Franz-Josef Lietz, Oberhausen-Lirich (DE); Sebastian Martens, Viersen (DE)

(73) Assignee: AUTO KABEL MANAGEMENTGESELLSCHAFT MBH, Hausen i.W. (DE)

(21) Appl. No.: 13/128,284

(22) PCT Filed: Oct. 29, 2009
(86) PCT No.: PCT/EP2009/064252

§ 371 Date: May 24, 2011

(30) Foreign Application Priority Data
Nov. 18, 2008 (DE) 10 2008 058 047.3

(51) Int. Cl. H02G 3/06; H01R 43/02

(52) U.S. Cl. 174/90; 29/879

(57) ABSTRACT

Connection of electrical cables comprising a connecting cable 2 formed from aluminium strands 4 and a metal connecting part 6. Contact corrosion is prevented when the welding takes place by firmly bonding the connecting cable 2 to the connecting part 6 by means of ultrasonic welding in such a way that a sealant 8 which is displaced between the connecting cable 2 and the connecting part 6 during the ultrasonic welding is situated between the aluminium strands 4.

The subject-matter relates to the connection of electrical leads, in particular energy-carrying leads in motor vehicles which have a connecting cable made of aluminium and a metal connecting part.

The extent to which stranded aluminium cables are being used in the automotive industry is steadily increasing. Because of its advantages in terms of weight, aluminium is preferred to copper in modern-day car-making. The connection of aluminium cables to one another, and also to other, metal conductors, for example of copper or alloys thereof, is proving to be something of a problem due to contact corrosion. Contact corrosion, which leads to increased contact resistance and, at worst, fracture of the electrical connection, occurs particularly in materially-bonded (firmly bonded, material fit) connections where moisture is able to make its way in at the point of contact between two different metals, for example aluminium and copper.

Particularly when stranded wires are welded by ultrasonic welding, a weld forms which, though homogeneous, is not fully (100%) compacted, as a result of which cavities in which moisture is able to collect form between the strands or in the interior of the weld. It is precisely these cavities which are a problem when different metals are used, because the moisture which is able to penetrate into them and collect in them acts as an electrolyte and may cause contact corrosion.

To prevent contact corrosion, what is conventionally done is to apply a sealant, such for example as a protective lacquer, a plastics material or some other hydrophobic material, around the weld. The sealant flows round the weld and thus prevents moisture from penetrating into it. However, there is a problem in this case, which is that the sealant is only applied to the weld subsequently to the welding. Moisture which was already present may cause contact corrosion. Also, moisture is able to get into the weld along the stranded wire itself, along the cavities which form between the strands, thus getting past the seal which has been made. Also, an uneven application of the protective layer or a mechanical stress may result in the corrosion protection ceasing to seal and in individual cavities no longer being sealed off. These results in moisture being able to penetrate into the weld and contact corrosion being able to occur on the strands.

Starting from the disadvantages outlined above, one object underlying the subject-matter was, when ultrasonic welding is used, to provide a connection protected against contact corrosion between strands of aluminium and a connecting part of, for example, non-ferrous metal.

This object is achieved by the invention by materially bonding the connecting cable to the connecting part by means of ultrasonic welding in such a way that a sealant which is displaced between the connecting cable and the connecting part during the ultrasonic welding is situated between the aluminium strands.

It has been realised that, with ultrasonic welding, it is possible for the welding of the metal parts to take place through the layer providing corrosion protection. Surprisingly, it has been found that sealant which is displaced during the welding moves into the spaces between the strands and each individual strand thus becomes sealed off from effects due to the ambient environment. The sealant is displaced in such a way that it either melts or burns. Parts of the sealant make their way from the weld seam into the cavities between the strands and thus seal these off from effects due to the ambient environment. The resultant connection of the electrical leads thus has good corrosion protection because substantially each individual weld seam between a stranded wire and the connecting part is protected by the sealant, in contrast to conventional methods of protection where only the outer boundary of the weld seam is protected.

When the ultrasonic welding takes place, the sealant in the form of a surface coating of a connecting part or of the connecting cable may already have cured or may still be wet. The connecting cable is pressed against the connecting part and is materially bonded to it by means of ultrasonic welding. When this is done, the connecting cable forces its way through the sealant and intermetallic contact occurs between connecting cable and connecting part. The sealant spreads out between the interfaces.

In an advantageous embodiment, the sealant is arranged on the connecting part before the ultrasonic welding takes place. The sealant may for example be sprayed on or painted on. It is even possible for the sealant to be extruded onto the connecting part.

In another advantageous embodiment, it is proposed that the sealant be arranged on as well as between the individual aluminium strands of the connecting cable before the ultrasonic welding takes place. In this case, it is for example possible for the connecting cable to be dipped into a sealant which is still liquid and for the sealant thus to be drawn in between the strands by capillary action. Each individual strand is then surrounded by sealant and the cavities are already filled with sealant. In this case, only the sealant on the sides of the aluminium strands adjacent the connecting part is displaced during the ultrasonic welding.

It is for example possible for the strands of aluminium to be welded to the connecting part at their end faces. It is also possible for the aluminium strands to be welded to the connecting part in the propagation direction.

When the sealant is displaced during the ultrasonic welding, it may melt or burn. In an advantageous exemplary embodiment it is proposed that a product of combustion which occurs be electrically conductive. In this case, even the products of combustion of the sealant do not result in increased contact resistance.

It is also proposed that the sealant be an adhesive. It is possible for an adhesive to be set to have optimum properties with regard to sealing against air and against moisture.

In an advantageous embodiment, it is proposed that the connecting part be formed from a non-ferrous metal. The use of copper or brass for example is possible in this case. Particularly when a non-ferrous metal is used for the connecting part and a connecting cable having aluminium strands is used, contact corrosion occurs if moisture is present at the point of connection. Such corrosion is prevented by the use of the sealant.

In an advantageous embodiment the connecting part is a flat part. A flat part may for example be a cable shoe or a flat conductor.

As has already been explained above, the sealant serves to provide corrosion protection in an advantageous embodiment.

A further aspect of the invention is a method of making an electrical connection between a connecting cable formed from aluminium strands and a connecting part by the application of a sealant to the aluminium strands and/or the connecting part, followed by the ultrasonic welding of the aluminium strands to the connecting part through the sealant, in such a way that a materially-bonded connection is made between the aluminium strands and the connecting part, the sealant being displaced and getting between the aluminium strands during the ultrasonic welding. In the method which has been described, a sealant is first applied either to the aluminium strands or to the connecting part. The aluminium strands may for example be dipped into a sealant which is still liquid. It is also possible for the sealant to be applied to the connecting part by extrusion, painting, dipping, powder coating or other suitable methods of coating.

Once the sealant has been applied to either the aluminium strands or the connecting part, the connecting part may be welded to the connecting cable by ultrasonic welding. When this is done, a materially-bonded connection is made between the connecting part and the aluminium strands through the sealant. This happens because of the input of energy from the ultrasonic welding, which first melts or burns the sealant and then causes the metal parts which are being joined to make an intermetallic, materially-bonded connection to one another.

It has been found that the sealant is displaced during the ultrasonic welding. Surprisingly, the sealant is not only displaced at the outer edges of the weld seam but also spreads to some degree along the cavities between the aluminium strands of the connecting cable. What is achieved in this way is that each individual aluminium strand is protected against contact corrosion by the sealant.

It is proposed that the sealant be applied to the aluminium strands by dipping. It is for example possible in this case for the sealant to be present in liquid form in a dipping bath. The end faces of the connecting cable may be dipped into the dipping bath, whereupon the sealant will be drawn into the cavities between the aluminium strands by capillary action. The strands which have been coated in this way can then be materially bonded. to the connecting part during the ultrasonic welding, the sealant being displaced in the region of the weld seam during the welding.

When it is displaced, at least some of the sealant may melt or burn in the region of the weld seam in an advantageous embodiment.

To enable the contact corrosion to be reliably prevented, it is proposed that the sealant fill cavities between the aluminium strands themselves and/or between them and the connecting part after the ultrasonic welding.

When this is the case, each individual intermetallic connection between a strand and the connecting part is sealed off against moisture and/or air by means of the sealant in an advantageous embodiment.

A further aspect of the subject-matter is the use of such a connection for an energy-carrying cable in a motor vehicle, in particular for a battery cable, a starter/generator cable or as part of the vehicle's electrical system.

The subject-matter will be explained in detail below by reference to a drawing showing exemplary embodiments. In the drawing:

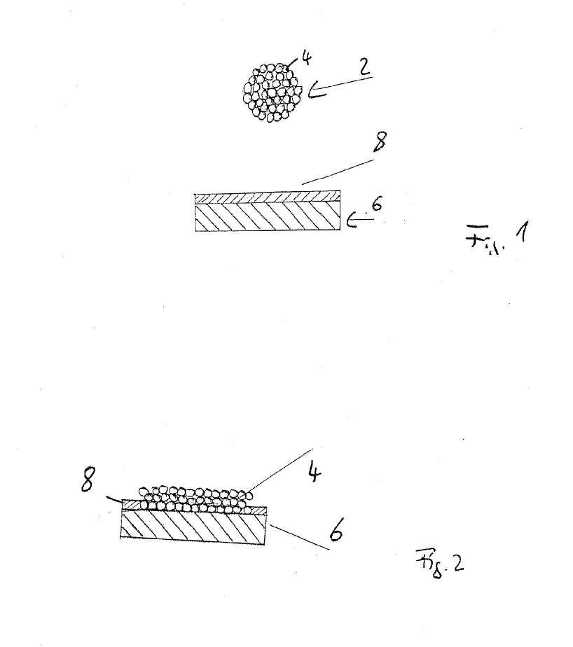

FIG. 1 shows a leading end of a stranded aluminium cable together with a coated connecting part.

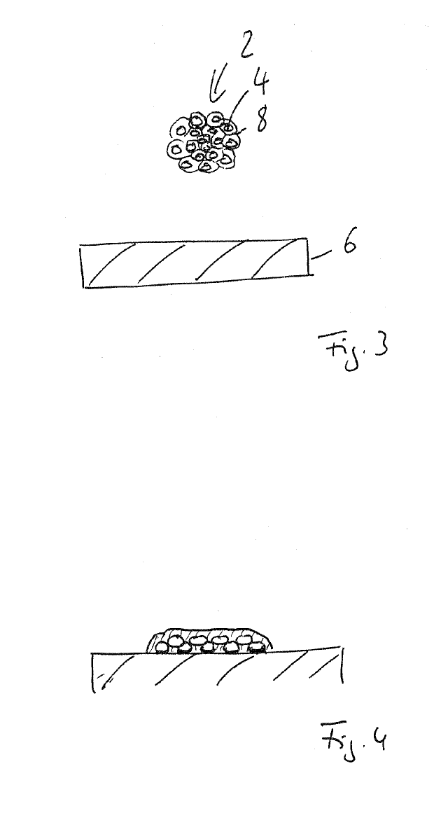

FIG. 2 shows an intermetallic connection which is made by ultrasonic welding.

FIG. 3 shows a coated, stranded aluminium conductor.

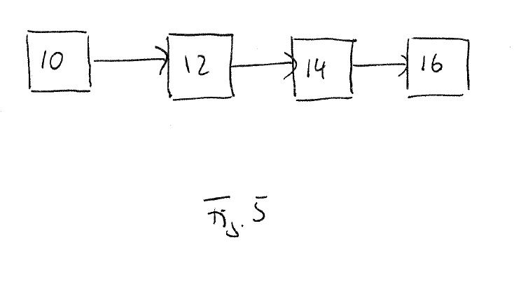

FIG. 4 shows an intermetallic connection between stranded aluminium conductor and connecting part.

FIG. 5 shows a method of making such a connection.

FIG. 1 shows a connecting cable 2 comprising a plurality of aluminium strands 4. The shown end face of the connecting cable 2 is bared in the region of the aluminium strands 4 but it could be insulated further up the lead. FIG. 1 also shows a connecting part 6 which has a layer 8 for corrosion protection, which layer 8 for corrosion protection is a sealant and has been applied to a plane surface of the connecting part 6. It can be seen that the layer 8 for corrosion protection has been applied to a plane surface of the connecting part 6, which latter may be a flat part. The application may be performed by painting, dip coating, extrusion, powder coating or similar processes. The layer 8 for corrosion protection may for example be an adhesive which is moisture-proof and/or air-proof.

For the connecting cable 2 to be welded to the connecting part 6, the connecting cable 2 is pressed against the layer 8 for corrosion protection in the region of the aluminium strands 4 by means of an ultrasonic welding tool (not shown). Following this, energy is fed into the point of contact between the aluminium strands and the layer 8 for corrosion protection by ultrasonic welding in such a way that the layer 8 for corrosion protection melts, burns, or is displaced. As shown in FIG. 2, the displaced layer for corrosion protection penetrates into the cavities between the aluminium strands 4. Material from the layer 8 for corrosion protection is situated in the region of substantially every point of contact between an aluminium strand 4 and the contacting part 6, in such a way that the layer 8 for corrosion protection seals off substantially every individual point of contact between connecting part 6 and aluminium strands 4 against air and/or moisture.

In the arrangement shown in FIG. 2, the layer 8 for corrosion protection is situated in the region of the points of contact between the very bottom layer of the aluminium strands 4 and the contacting part 6, because at this point there is an intermetallic connection between two different metals. At the points of contact, the aluminium strands 4 rest down on the material of the connecting part 6, which may be made of copper. Because of the differing potentials of the parts of the connection, the intermetallic connection is prone to contact corrosion. Because the layer 8 for corrosion protection seals off the connection against air and/or moisture in the region of the said connection, contact corrosion can be prevented. Because, as it melts, the layer 8 for corrosion protection makes its way into the cavities between the individual strands, it is substantially the entire weld seam and not just the external region which is protected against contact corrosion.

FIG. 3 shows an embodiment in which the surface of the connecting part 6 is not coated; instead the layer 8 for corrosion protection is situated. around each individual aluminium strand 4 of the connecting cable 2. The layer 8 for corrosion protection surrounds substantially all the aluminium strands 4 in this case. The cavities between the aluminium strands 4 are substantially filled by the layer 8 for corrosion protection. Rather than being as shown, the leading ends are also coated by the layer 8 for corrosion protection.

By ultrasonic welding, the aluminium strands 4 are pressed against the connecting part 6 in such a way that the layer 8 for corrosion protection melts, burns or is displaced in the region of the point of contact between the aluminium strands 4 and the connecting part 6. As its burns, the product of combustion from the layer 8 for corrosion protection may be such that it is electrically conductive. The medium for protecting against corrosion may also be of a form such that it is liquid or paste-like before the welding and cures due to the temperatures which occur during the welding. When the connecting cable 2 is welded ultrasonically to the connecting part 6, the layer 8 for corrosion protection flows around the aluminium strands 4 in such a way that the cavities between the strands are substantially filled with the layer 8 for corrosion protection and in particular the points of contact between the connecting part 6 and the aluminium strands 4 are surrounded by layer 8 for corrosion protection, thus enabling contact corrosion to be reliably prevented.

FIG. 5 is a flow chart of a method to which the subject-matter relates. In a first step 10, an end of the connecting cable 2 which has been bared is dipped into a liquid sealant by its aluminium strands 4. In step 10, it is also possible not for the aluminium strands to be dipped into the sealant but for a surface of the connecting part to be coated with sealant, for example the layer 8 for corrosion protection.

In a next step 12, the connecting cable is pressed against the connecting part 6 in the region of the aluminium strands 4, which have been provided with the layer 8 for corrosion protection, by means of an ultrasonic welding tool. Then, in step 14, the layer 8 for corrosion protection is melted, burnt or displaced in the region of the point of contact, and thus flows into the cavities between the aluminium strands 4. In this step the aluminium strands 4 are resting directly against the connecting part 6 and the input of energy from the ultrasonic welding tool causes the aluminium strands 4 to be materially bonded to the connecting part 6 by means of an intermetallic joint. In this step 14, the layer 8 for corrosion protection flows around the points of contact between the aluminium strands 4 and the connecting part 6 even in the region of the cavities between the aluminium strands 4.

After the cooling step 16, the aluminium strands 4 are protected against contact corrosion in the region of the point of contact with the connecting part 6 by the layer 8 for corrosion protection.

By virtue of the method to which the subject-matter relates and the connection to which the subject-matter relates, it is possible for stranded aluminium cables to be connected to connecting parts, of copper for example, without the problem of contact corrosion arising. What is made by this means is a durable, secure and reliable electrical connection between aluminium strands and connecting part.

1-14. (canceled)

15. Connection of electrical leads, in particular of energy carrying leads in motor vehicles, comprising:
a connecting cable formed from aluminium strands and a metal connecting part, wherein the connecting cable is materially bonded to the connecting part by means of ultrasonic welding in such a way that a sealant which is displaced from between the connecting cable and the connecting part during the ultrasonic welding is located between the aluminium strands .

16. Connection of claim 15, wherein the sealant is arranged on the connecting part before the ultrasonic welding takes place.

17. Connection of claim 15, wherein the sealant is arranged at the aluminium strands of the connecting cable before the ultrasonic welding takes place.

18. Connection of claim 15, wherein a product of combustion produced by the sealant is electrically conductive.

19. Connection of claim 18, wherein the sealant is a corrosion protective.

20. Connection of claim 15, wherein the sealant is an adhesive.

21. Connection of claim 15, wherein the connecting part is formed from a non-ferrous metal.

22. Connection of claim 21, wherein the sealant is a corrosion protective.

23. Connection of claim 15, wherein the connecting part is a flat part.

24. Connection of claim 15, wherein the sealant is a corrosion protective.

25. Connection of claim 15, wherein the connecting cable is disposed in a motor vehicle, in any of a battery cable, a starter/generator cable or as part of the vehicle's electric system.

26. Method of making an electrical connection between a connecting cable formed from aluminium strands and a connecting part comprising:
applying a sealant to the aluminium strands and/or the connecting part; and
ultrasonic welding of the aluminium strands to the connecting part through the sealant, in such a way that a materially-bonded connection is formed between the aluminium strands and the connecting part, whereby the sealant being displaced during the ultrasonic welding and gets between the aluminium strands.

27. Method of claim 26, wherein the sealant is applied to the aluminium strands by dipping.

28. Method of claim 26, wherein, when it is displaced, at least some of the sealant melts, burns or is displaced in the region of the weld seam.

29. Method of claim 26, wherein the sealant fills cavities between the aluminium strands after the ultrasonic welding.

30. Method of claim 26, wherein the sealant seals off the weld seam against moisture and/or air.
